(19) United States
(12) Patent Application Publication
(10) Pub. No.: US 2024/0364122 A1
(43) Pub. Date: Oct. 31, 2024

(54) CELL BALANCE SWITCH CIRCUIT, BATTERY MONITORING DEVICE, BATTERY SYSTEM

(71) Applicant: LAPIS Technology Co., Ltd., Yokohama (JP)

(72) Inventor: Ryo MATSUMOTO, Yokohama (JP)

(73) Assignee: LAPIS Technology Co., Ltd., Yokohama (JP)

(21) Appl. No.: 18/642,827

(22) Filed: Apr. 23, 2024

(30) Foreign Application Priority Data
Apr. 27, 2023 (JP) 2023-073776

(51) Int. Cl. H02J 7/00

(52) U.S. Cl. CPC H02J 7/0016; H02J 7/007182

(57) ABSTRACT

A cell balance switch circuit 17 includes: electrodes 23; conductive wires 25, respectively connected with the electrodes 23; and cell balance switches 27, connected between adjacent two conductive wires among the conductive wires 25. Each cell balance switch 27 includes: a first transistor 31, connected between adjacent conductive wires 25; a bias wire 33, connected with a gate (G) of the first transistor 31; and a suppression circuit 35, connected between the bias wire 33 and the conductive wire 25. The suppression circuit 35 includes a switch 37 temporarily connecting the bias wire 33 and the conductive wire 25 responsive to a voltage change of the conductive wire 25.

### CROSS-REFERENCE TO RELATED APPLICATION

This application claims priority under 35 USC 119 from Japanese Patent application No. 2023-073776 filed on Apr. 27, 2023, the disclosure of which is incorporated by reference herein.

### BACKGROUND

### Technical Field

The disclosure relates to a cell balance switch circuit, a battery monitoring device, and a battery system.

### Description of Related Art

Japanese Laid-open No. 2015-211583 discloses a battery monitoring device. The battery monitoring device prevents undesired discharge of a battery cell due to an undesired operation of a cell balance control terminal of a cell balance circuit.

A battery monitoring device balances terminal voltages of cells in a cell string containing battery cells connected in series. Specifically, the battery monitoring device includes multiple switch elements. The switch elements are connected to the respective battery cells in serial connection in the cell string. The battery monitoring device controls the switch elements to discharge battery cells with a high charge amount to equalize the charge amounts of the battery cells.

The battery monitoring device is compatible with hot-wire insertion and extraction (inserted and removed) to a battery device including the battery string. When the battery device is integrated with the battery monitoring device connected with a power source, terminals from cathodes and anodes of adjacent cells in the serial connection of the cell string are connected to corresponding electrodes of the battery monitoring device.

The contact between individual terminals and corresponding electrodes does not occur exactly at the same time, but occurs in different orders from one insertion to another. At the time of insertion, it is possible that a voltage that violates breakdown voltage be applied to the switch of the battery monitoring device. However, no solution has been found to control the contact timings between all the terminals and electrodes when the battery device and the battery monitoring device are integrated.

In order to prevent a voltage that violates breakdown voltage from being applied to the switch, an external Zener diode is connected with the electrode of the battery monitoring device.

The disclosure provides a cell balance switch circuit, a battery monitoring device, and a battery system capable of alleviating the inequality of the between-terminal voltages of cell balance switches, which may occur when a stack of battery cells in a cell string and a stack of cell balance switches are connected.

### SUMMARY

A cell balance switch circuit according to a first aspect of the disclosure includes: (n+1) electrodes, configured to be each connected with a common node of adjacent two battery cells in a cell string including n battery cells connected in series; (n+1) conductive wires, respectively connected with the electrodes; and n cell balance switches, configured to be connected between adjacent two conductive wires among the conductive wires. Each of the cell balance switches includes: a first transistor, connected between adjacent conductive wires of the conductive wires; a bias wire, connected with a gate of the first transistor; and a suppression circuit configured to be connected between the bias wire and the conductive wire. The suppression circuit includes a switch configured to temporarily connect the bias wire and the conductive wire in response to a voltage change of the conductive wire.

A battery monitoring device according to a second aspect of the disclosure includes: the cell balance switch circuit according to the first aspect; a cell selecting switch circuit, including cell selecting switches respectively connected with the cell balance switches; and a cell voltage measuring circuit, connected with a first line and a second line, wherein the first line is connected with odd-numbered electrodes among the electrodes via the cell balance switch circuit and the cell selecting switch circuit, and the second line is connected with even-numbered electrodes among the electrodes via the cell balance switch circuit and the cell selecting switch circuit.

A battery system according to a third aspect of the disclosure includes: the battery monitoring device according to the second aspect; and a cell string, including n battery cells connected in series.

### BRIEF DESCRIPTION OF THE DRAWINGS

FIG. 1 is a schematic diagram illustrating a battery system according to an embodiment.

FIG. 2 is a schematic diagram illustrating a cell balance switch circuit of a battery monitoring device according to an embodiment.

FIG. 3 is a schematic diagram illustrating a suppression circuit, as an example, of the battery system according to an embodiment.

FIG. 4 is a schematic diagram illustrating a suppression circuit, as an example, of the battery system according to an embodiment.

FIG. 5 is a schematic circuit diagram illustrating, as an example, a polarity switch circuit of the battery monitoring device according to an embodiment.

FIG. 6 is a schematic circuit diagram illustrating, as an example, a cell selecting switch of the battery monitoring device according to an embodiment.

FIG. 7 is a schematic diagram illustrating the battery system according to an embodiment.

FIG. 8 is a schematic diagram illustrating a battery system without the suppression circuit.

FIG. 9 is a diagram illustrating a voltage waveform of a power wire of the battery monitoring device and voltage waveforms of all the conductive wires of the battery monitoring device during starting of the battery system of FIG. 8.

FIG. 10 is a diagram illustrating gate-source voltages (VGS) of p-type and n-type transistors of cell balance switches in the battery system shown in FIG. 8.

FIG. 11 is a schematic diagram illustrating a battery system having the suppression circuit.

FIG. 12 is a diagram illustrating a voltage waveform of a power wire of the battery monitoring device and voltage waveforms of all the conductive wires of the battery monitoring device during starting of the battery system of FIG. 11.

FIG. 13 is a diagram illustrating gate-source voltages (VGS) of p-type and n-type transistors of the cell balance switches in the battery system shown in FIG. 11.

### DESCRIPTION OF THE EMBODIMENTS

According to the cell balance switch circuit, the batter monitoring device, and the battery system, the inequality of voltages among terminals of a cell balance switch, which may occur when a stack of battery cells in a cell string and a stack of cell balance switches are connected.

In the following, embodiments for implementing the disclosure are described with reference to the drawings. In the following description, like or similar portions are labeled with like or similar symbols, and repeated description will be omitted.

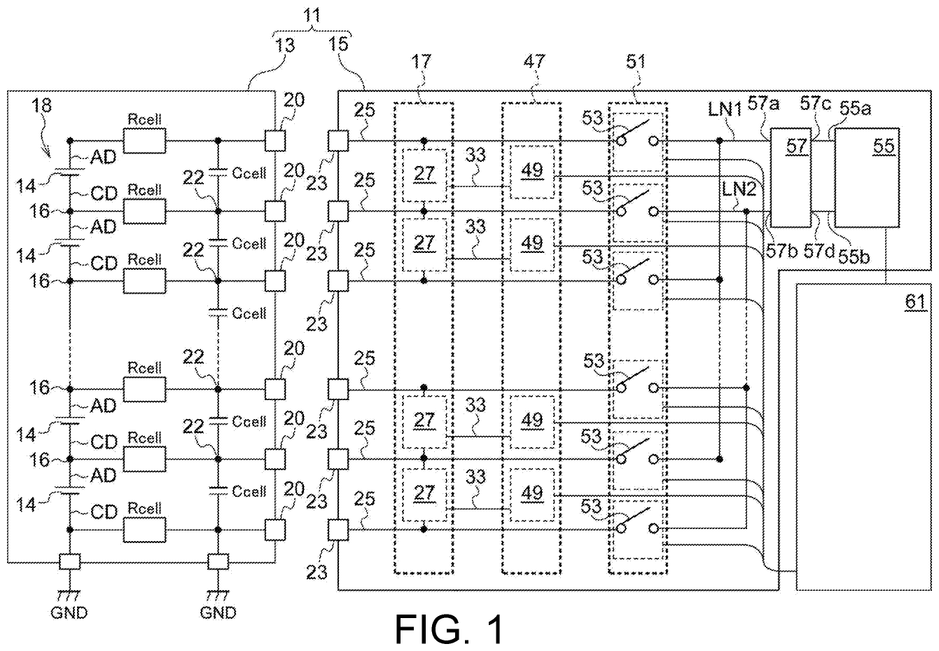

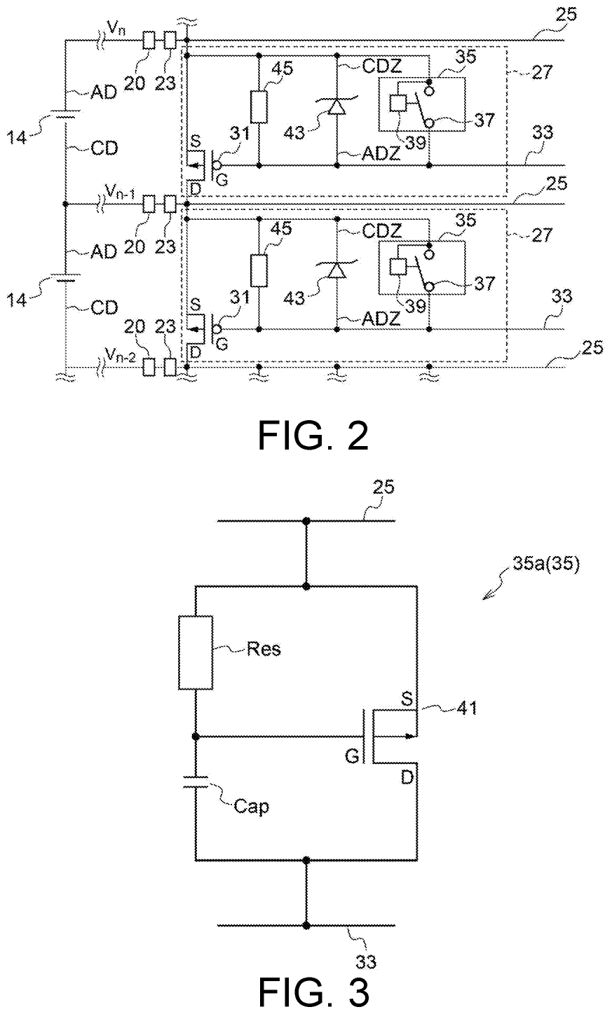

FIG. 1 is a schematic diagram illustrating a battery system according to an embodiment. A battery system 11 includes a battery device 13 and a battery monitoring device 15. FIG. 2 is a schematic diagram illustrating a cell balance switch circuit of a battery monitoring device according to an embodiment. In FIG. 2, circuit symbols of transistors are shown. In the following description, gates, drains, sources of transistors are shown by using symbols “G”, “D”, and “S”.

Referring to FIG. 1, the battery device 13 has a cell string 18 having n battery cells 14 in serial connection. Adjacent two battery cells 14 among the battery cells 14 in the cell string 18 are connected with each other at a common node 16. An anode AD of one of the battery cells 14 and a cathode CD of the other battery cell 14 are connected with each other at the common node 16. Each battery cell 14 contains a unit of lithium battery that performs charge, discharge, and cell balance processes, and contains a battery device that includes multiple units of lithium battery. The expression “cell” does not necessarily refer to a physical lithium battery cell. The battery device 13 includes battery electrodes 20 connected to the respective common nodes 16. In FIG. 1, the battery device 13 is not connected with the battery monitoring device 15.

The battery monitoring device 15 includes a cell balance switch circuit 17. The cell balance switch circuit 17 includes (n+1) electrodes 23, (n+1) conductive wires 25, and n cell balance switches 27. The electrodes 23 are configured to be connected with the respective common nodes 16 of the battery cells 14. The conductive wires 25 are connected with the respective electrodes 23. The cell balance switch 27 is configured to be connected with adjacent two conductive wires 25 among the conductive wires 25.

Referring to FIGS. 1 and 2, each of the cell balance switches 27 includes a first transistor 31, a bias wire 33, and a suppression circuit 35. The bias wire 33 is connected with the gate (G) of the first transistor 31, and the source (S) and the drain (D) of the first transistor 31 are connected between the respective adjacent conductive wires 25 (the conductive wire 25 on the anode side and the conductive wire 25 on the cathode side). The first transistor 31 can be a p-type or n-type MOS transistor.

At least some of the first transistors 31 of the cell balance switches 27 can have a p-channel type. According to the cell balance switch circuit 17, the p-channel type first transistor 31 can be provided at the cell balance switch 27 on a high potential side of the cell string 18. In addition, at least some of the first transistor 31 of the cell balance switch 27 can have an n-channel type. According to the cell balance switch circuit 17, the n-channel type first transistor 31 can be provided at the cell balance switch 27 on a low potential side of the cell string 18.

A back gate (substrate terminal) of the first transistor 31 is connected with the source (S). According to the cell balance switch circuit 17, the first transistors 31 of the individual cell balance switches 27 are provided with thresholds of the same level, regardless of the stages of the cell balance switches 27.

The suppression circuit 35 is formed to be connected between the conductive wire 25 and the bias wire 33. The suppression circuit 35 includes a switch 37. The switch 37 is formed to temporarily connect the conductive wire 25 and the bias wire 33 in response to a voltage change of the conductive wire 25.

According to the cell balance switch circuit 17, when the cell voltage from the battery cell 14 of the cell string 18 is applied to the electrode 23 of the cell balance switch circuit 17, the cell voltage changes the voltage of the conductive wire 25 connected with the electrode 23. In response to the voltage change on the individual conductive wire 25, the switch 37 of the suppression circuit 35 is temporarily turned on to suppress the voltage change of the bias wire 33 through capacity coupling between the source (S) and the gate (G) of the first transistor 31. Suppressing the voltage change can prevent the first transistor 31 of the cell balance switch 27 from being turned on unintendedly.

The suppression circuit 35 further includes a delay circuit 39. The delay circuit 39 is connected between the conductive wire 25 (conductive wire 25 connected to the source (S) of the first transistor 31) associated with the suppression circuit 35 and the conductive wire 25 of the switch 37.

According to each cell balance switch 27 of the cell balance switch circuit 17, the delay circuit 39 can, after the delay time of the delay circuit 39, temporarily connect the bias wire 33 and the conductive wire 25 by turning off the switch 37 turned on in response to the rising of the conductive wire 25 connected with the source (S) of the first transistor 31.

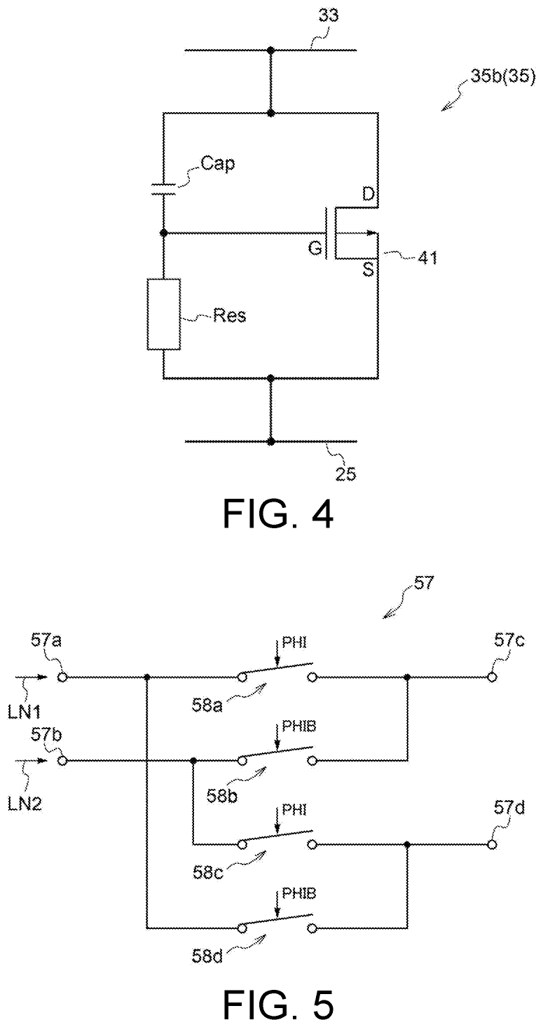

FIG. 3 is a schematic diagram illustrating the suppression circuit, as an example, of the battery system according to an embodiment. FIG. 4 is a schematic diagram illustrating the suppression circuit, as an example, of the battery system according to an embodiment.

As shown in FIGS. 3 and 4, the exemplary suppression circuit 35 (35a, 35b) includes a second transistor 41. The source (S) and the drain (D) of the second transistor 41 are respectively connected with the conductive wire 25 (conductive wire 25 connected with the source (S) of the first transistor 31) and the bias wire 33 associated with the suppression circuit 35.

According to the cell balance switch circuit 17, the threshold of the second transistor 41 is provided for the threshold of the switch 37 of the suppression circuit 35.

A back gate (substrate terminal) of the second transistor 41 is connected with the source (S). According to the cell balance switch circuit 17, the threshold of the second transistor 41 is provided for the threshold of the cell balance switch 27 of the suppression circuit 35, regardless of the stage of the cell balance switch 27.

According to each cell balance switch 27 of the cell balance switch circuit 17, the second transistor 41 can temporarily connect the conductive wire 25 connected with the source (S) of the first transistor 31 and the bias wire 33. The temporary connection allows the voltage of the conductive wire 25 to be applied to the gate (G) of the transistor 41 to prevent the potential difference between the gate (G) and the source (S) of the second transistor 41 from increasing.

The delay circuit 39 of the suppression circuit 35 is connected between the conductive wire 25 connected with the source (S) of the first transistor 31 and the gate (G) of the second transistor 41. Specifically, the delay circuit 39 includes a resistor Res and a capacitor Cap. The capacitor Cap is connected between the bias wire 33 and the gate (G) of the second transistor 41. The resistor Res is connected between the conductive wire 25 and the gate (G) of the second transistor 41.

According to each cell balance switch 27 of the cell balance switch circuit 17, the delay circuit 39 can, after the delay time of the delay circuit 39, temporarily connect the bias wire 33 and the conductive wire 25 by turning off the second transistor 41 turned on temporarily in response to the rising of the conductive wire 25 connected with the source (S) of the first transistor 31.

The source (S) of the second transistor 41 is connected with the conductive wire 25. When the potential of the conductive wire 25 changes, the capacitor Cap operates to apply a potential close to the bias wire 33 to the gate (G) of the second transistor 41. Therefore, with the potential change of the conductive wire 25, the potential difference between the gate (G) and the source (S) of the second transistor 41 temporarily increases. Meanwhile, the voltage of the conductive wire 25 charges the capacitor Cap via the resistor Res. When the potential of an end of the capacitor Cap crosses the threshold of the second transistor 41 through charging, the second transistor 41 is turned off.

Specifically, when the first transistor 31 has the p-type, the second transistor 41 is provided with the p-type. When the first transistor 31 has the n-type, the second transistor 41 is provided with the n-type. Therefore, the conductivity type of the second transistor 41 can be the same as the conductivity type of the first transistor 31. With the conductivity type being the same, a switch that is temporarily turned on can be provided by using the potential change of the conductive wire 25 with respect to the bias wire 33.

Referring to FIG. 2 again, the cell balance switch 27 can be further provided with a diode 43 connected in a reverse direction between the bias wire 33 and the conductive wire 25. The diode 43 can be a Zener diode. An anode ADZ of the diode 43 is connected with the bias wire 33, and a cathode CDZ of the diode 43 is connected with the conductive wire 25. The diode 43 can protect the first transistor 31 of the cell balance switch 27 and the second transistor 41 of the suppression circuit 35.

The cell balance switch 27 can further include a resistor 45 connected between the bias wire 33 and the conductive wire 25. It is possible for the resistor 45 to exert control to turn on and turn off the first transistor 31 in response to the control of the voltage of the bias wire 33 or the current flowing through the bias wire 33. Since the bias wire 33 is provided for each cell balance switch 27, the control of turning on and turning off the first transistor 31 can be performed for each cell balance switch 27.

Referring to FIG. 1 again, the cell monitoring device 15 can further include a cell selecting switch circuit 51. The cell selecting switch circuit 51 can include a cell selecting switch 53 connected with each of the cell balance switches 27. The cell selecting switch 53 is connected with each of the conductive wires 25.

In addition, the battery monitoring device 15 can further include a cell voltage measuring circuit 55. The cell voltage measuring circuit 55 can measure a between-terminal voltage of the battery cell 14 selected by the cell selecting switch circuit 51.

The battery monitoring device 15 can further include a polarity switch circuit 57 connected between the cell selecting switch circuit 51 and the cell voltage measuring circuit 55.

The conductive wires 25 are connected with the respective common nodes 16 of the cell string 18. When the voltage of a battery cell 14 in the cell string 18 is monitored, adjacent two conductive wires 25 are selected by adjacent two cell selecting switches 53 in the cell selecting switch circuit 51.

Specifically, in the battery cell 14 of the first stage in the cell string 18, the cathode of the battery cell 14 is connected with the first conductive wire 25, and the anode of the battery cell 14 is connected with the second conductive wire 25. In the battery cell 14 of the second stage in the cell string 18, the cathode of the battery cell 14 is connected with the second conductive wire 25, and the anode of the battery cell 14 is connected with the third conductive wire 25. The second conductive wire 25 is connected with the anode of the battery cell 14 of the first stage and the cathode of the battery cell 14 of the second stage.

The cell selecting switch 53 in the cell selecting switch circuit 51 selects the battery cell 14 of the measurement target and, in response to the selection, the polarity switch circuit 57 adjusts line connection. The polarity switch circuit 57 switches the voltage polarities for the adjacent two conductive wires 25 at the time of measuring the battery cell 14 of an even-numbered stage and the battery cell 14 of an odd-numbered stage to connect the cathode and the anode of the battery cell 14 of the measurement target to the cell voltage measuring circuit 55.

Specifically, the polarity switch circuit 57 has a first input 57a and a second input 57b. The first input 57a is connected with a first line LN1 from the cell selecting switch 53 associated with the odd-numbered conductive wire 25. The second input 57a is connected with a second line LN2 from the cell selecting switch 53 associated with the even-numbered conductive wire 25. The polarity switch circuit 57 has a first output 57c and a second output 57d. The first output 57c of the polarity switch circuit 57 is connected with a high potential input 55a of the cell voltage measuring circuit 55. The second output 57d is connected with a low potential input 55b of the cell voltage measuring circuit 55.

FIG. 5 is a schematic circuit diagram illustrating, as an example, a polarity switch circuit of the battery monitoring device according to an embodiment.

The exemplary polarity switch circuit 57 has four switches (58a, 58b, 58c, 58d). Switches (58a, 58c) operate in response to a switching signal PHI. Switches (58b, 58d) operate in response to a switching signal PHIB obtained by inverting the switching signal PHI. The switch (58a) is connected between the first input 57a and the first output 57c. The switch (58b) is connected between the second input 57b and the first output 57c. The switch (58c) is connected between the second input 57b and the second output 57b. The switch (58d) is connected between the first input 57a and the second output 57b.

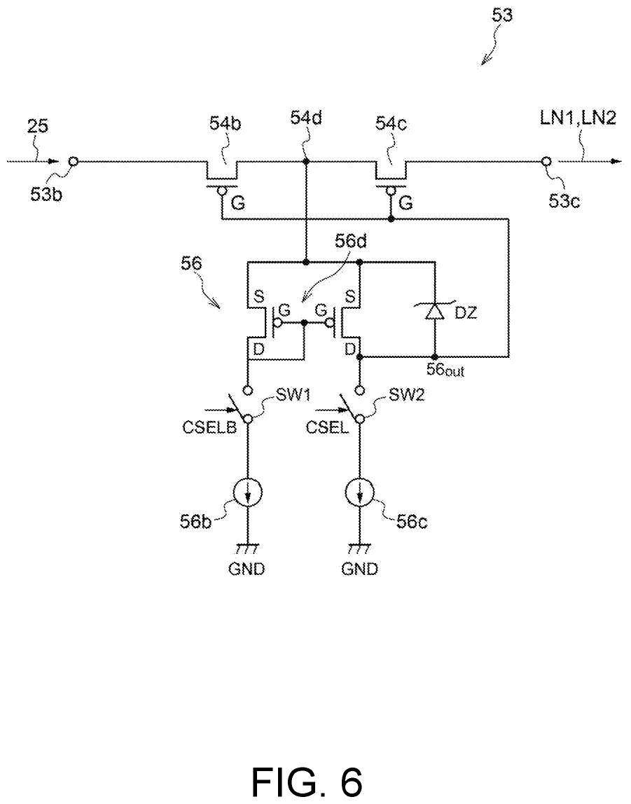

FIG. 6 is a schematic circuit diagram illustrating, as an example, a cell selecting switch of the battery monitoring device according to an embodiment.

The exemplary selecting switch 53 has an end 53b and an other end 53c. The cell selecting switch 53 has a third transistor 54b and a fourth transistor 54c connected between the end 53b and the other end 53c to form a current path. The third transistor 54b and the fourth transistor 54c are connected with each other at a common node 54d. The cell selecting switch 53 includes a switch circuit 56 connected between the common node 54d and a power wire (e.g., GND). The switch circuit 56 includes a first current source 56b, a second current source 56c, switches SW1 and SW2, a Zener diode DZ, and a current mirror circuit 56d. The input part of the current mirror circuit 56d is connected with the first current source 56d via the switch SW1 in response to a selection signal CSELB. The output part of the current mirror circuit 56d is connected with the second current source 56c via the switch SW2 in response to a selection signal CSEL. The output part of the current mirror circuit 56d is connected with an output 56out of the switch circuit 56. The cathode of the Zener diode DZ is connected with the common node 54d, and the anode is connected with the output 56out.

In the switch circuit 56, when the switch SW1 opens in response to the switching signal (CSELB) and the switch 2 closes in response to the switching signal (CSEL), the current of the second current source 56c flows to the Zener diode DZ, and the voltage of the output 56out is not at the potential of the power wire (e.g., GND), but at a potential lower than the potential of the common node 54d by a reverse voltage of the Zener diode DZ. The third transistor 54b and the fourth transistor 54c are turned on.

When the switch SW1 closes in response to the switching signal (CSLEB) and the switch SW2 opens in response to the switching signal (CSEL), the current of the first current source 56b flows to the input part of the current mirror circuit 56d to turn on the output part of the current mirror circuit 56d. The voltage of the output 56out becomes the voltage of the common node 54d. The potential of the common node 56d becomes a value approximately equal to the threshold.

Referring to FIG. 1 again, the battery monitoring device 15 can further include a control circuit 47 controlling the cell balance switches 27. The control circuit 47 includes n bias wire control circuits 49. The bias wire control circuit 49 is connected with the bias wire 33 in each of the cell balance switches 27 to control the voltage or the current of the bias wire 33.

In order to exert control to turn on or off the first transistor 31 of the cell balance switch 27, the exemplary bias wire control circuit 49 performs to flow a current of a certain value or set the current vale to zero. The current from the bias wire control circuit 49 flows to the resistor 45 of the cell balance switch 27. The potential of the gate (G) of the first transistor 31 is specified in response to the resistance of the resistor 45. When the potential difference between the gate (G) and the source (S) is greater than the threshold of the first transistor 31, the first transistor 31 is turned on. When the current from the bias wire control circuit 49 is zero, the potential difference between the gate (G) and the source (S) is zero. Therefore, the first transistor 31 is turned off. The bias wire control circuit 49 is connected with the conductive wire via the resistor 45.

Referring to FIG. 1 again, the battery device 13 has a cell capacitor Ccell connected between the anode AD and the cathode CD of the battery cell 14. An end of the cell capacitor Ccell is connected with the common node 16 via the cell resistor Rcell. The battery electrode 20 is connected with each common node 22 of adjacent two cell capacitors Ccell in a cell capacitor string including n cell capacitors Ccell connected in series. The anode of the uppermost battery cell 14 of the cell string 18 is not connected with the common node 16, but is connected with an end of the corresponding cell capacitor Ccell and the battery electrode 20 via the cell resistor Rcell. The cathode of the lowermost battery cell 14 of the cell string 18 is not connected with the common node 16, but is connected with the other end of the corresponding capacitor Ccell and the battery electrode 20 via the resistor Rcell.

The battery system 11 may further include a controller 61. The controller 61 can be configured to receive data relating to a charge voltage of the battery cells 14 of the cell string 18, specify one or more battery cells 14 on which cell balancing is supposed to perform in the cell string 18 based on the data, and provide the selection signal to the bias wire control circuits 49 connected with the cell balance switches 27 connected with the specified one or more battery cells 14 to turn on the cell balance switches 27.

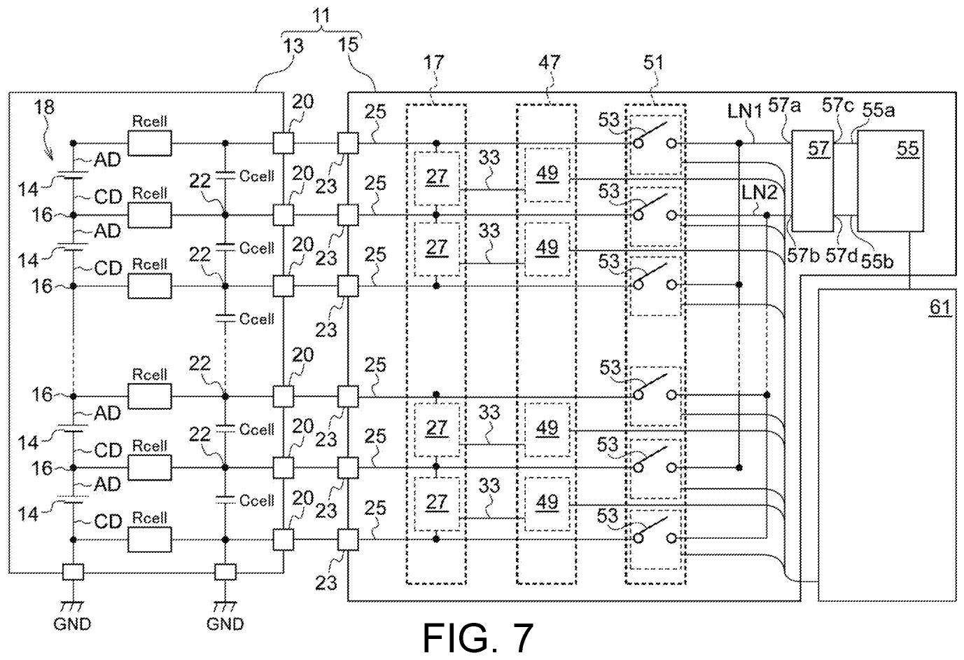

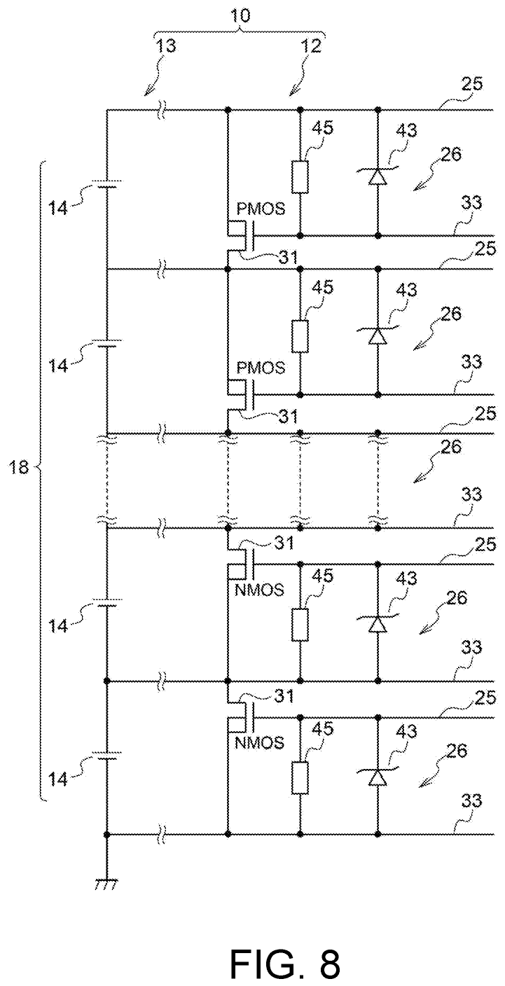

FIG. 7 is a schematic diagram illustrating a battery system according to an embodiment. In the battery system 11, the battery device 13 and the battery monitoring device 15 are connected with each other. Specifically, after the power voltage is applied to the battery monitoring device 15, as shown in FIG. 8, the battery device 13 is connected with the battery monitoring device 15. In addition, the battery device 13 is cut off from the battery monitoring device 15 while the power voltage is applied to the battery monitoring device 15. In this way, hot-wire insertion and extraction is performed in the battery system 11.

FIG. 8 is a schematic diagram illustrating a battery system without the suppression circuit. In FIG. 8, like or similar portions with respect to the battery system 11 of FIG. 7 are labeled with like or similar symbols, and redundant description will be omitted. In the battery system 10 of FIG. 8, the battery device 13 has, for example, 17 stages of the battery cells 14 connected in series. The battery monitoring device 12 has 17 stages of cell balance switches 26 connected in series. Specifically, the cell balance switches 26 of two low-potential stages among the 17 stages of the cell balance switches 26 include n-type transistors, and the remaining 15 cell balance switches 26 include p-type transistors.

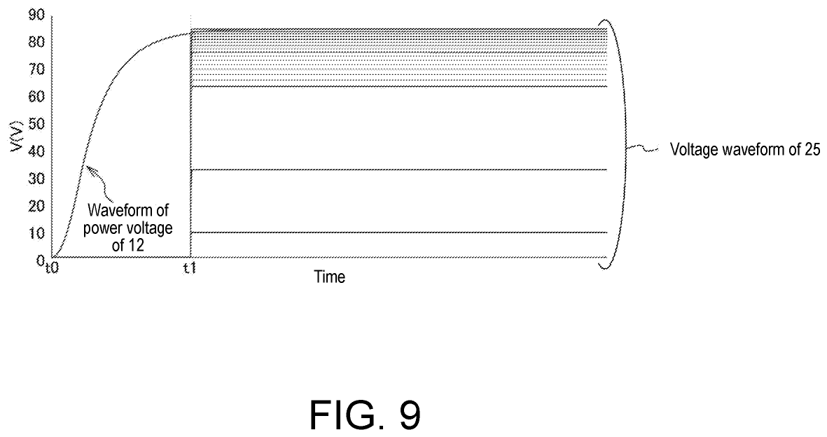

FIG. 9 is a diagram illustrating a voltage waveform of a power wire of the battery monitoring device and voltage waveforms of all the conductive wires of the battery monitoring device during starting of the battery system of FIG. 8.

At the time to, power is supplied to the battery monitoring device 12. The potentials of the conductive wires 25 and the bias wires 33 of the battery monitoring device 12 are undefined. After a sufficient power voltage is supplied to the battery monitoring device 12, at the time t1, the battery device 13 is connected with the battery monitoring device 12 (hot-swap). The conductive wires 25 of the battery monitoring device 12 receive power from the respective corresponding battery cells 14. The battery cells 14 of the battery device 13 supply power to the conductive wires 25 via the cell capacitors Ccell and the cell resistors Rcell.

Referring to FIG. 9, in the battery monitoring device 12, the interval between the potentials of the conductive wires 25 on the high potential side decreases, and the interval between the potentials of the conductive wires 25 on the low potential side increases. A large interval of the potentials of the conductive wires 25 indicates that a large voltage is applied to the transistor of the cell balance switch 26. This indicates a violation of the breakdown voltage of the transistor of the cell balance switch 26.

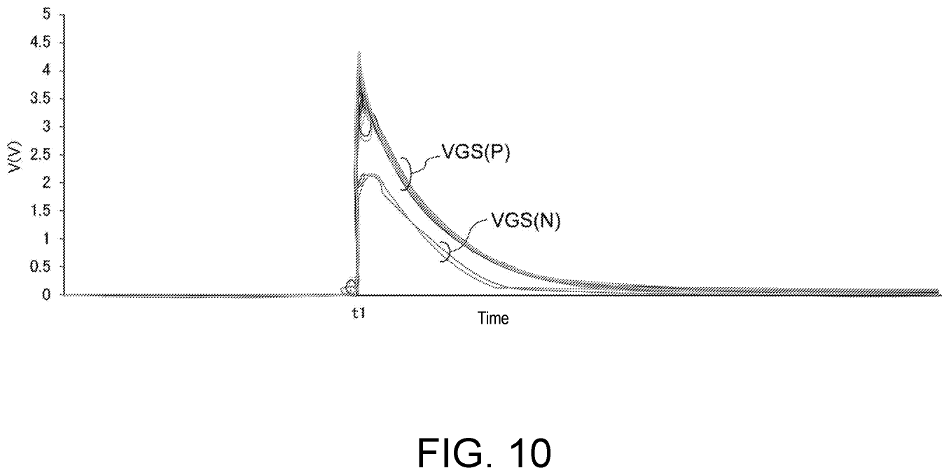

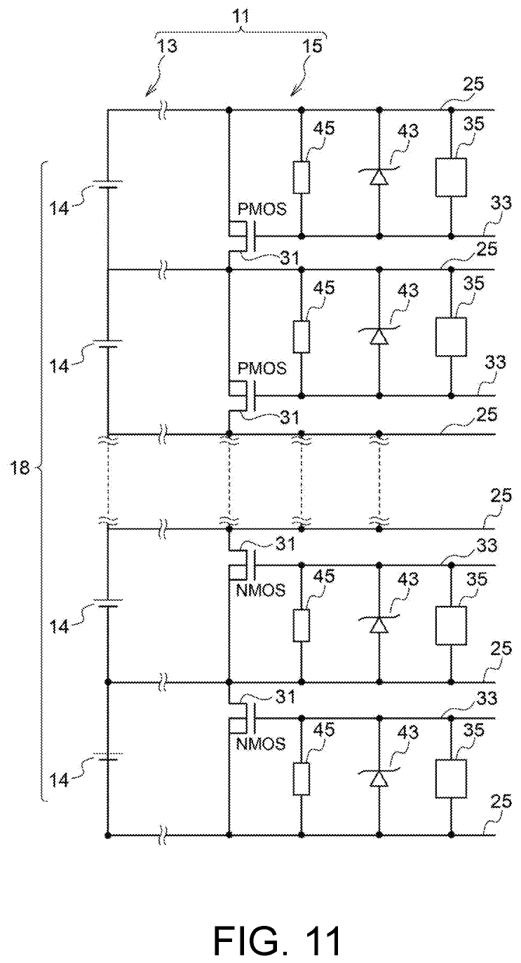

FIG. 10 is a diagram illustrating gate-source voltages (VGS) of p-type and n-type transistors of the cell balance switches 26 in the battery system shown in FIG. 8.

At the time t1, in accordance with the hot-swap, the gate-source voltages (VGS (p) and VGS (n)) of the p-type transistor and the n-type transistor of the cell balance switch 26 change significantly temporarily. This is due to the capacity coupling between the sources(S) and the gates (G) of the transistors of the cell balance switch 26. The voltage change of the p-type transistor is greater than the voltage change of the n-type transistor. This is because that the size of the p-type transistor is greater than the size of the n-type transistor.

FIG. 11 is a schematic diagram illustrating a battery system having the suppression circuit. In the battery system 11 of FIG. 11, the battery device 13 has, for example, 17 stages of the battery cells 14 connected in series. The battery monitoring device 15 has 17 stages of cell balance switches 27 connected in series. Specifically, the cell balance switches 27 of two low-potential stages among the 17 stages of the cell balance switches 27 include n-type transistors, and the remaining 15 cell balance switches 27 include p-type transistors.

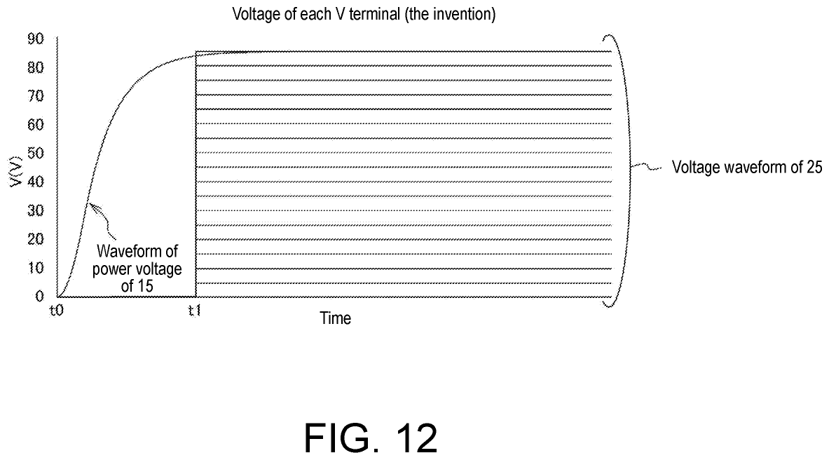

FIG. 12 is a diagram illustrating a voltage waveform of a power wire of the battery monitoring device and voltage waveforms of all the conductive wires of the battery monitoring device during starting of the battery system of FIG. 11.

At the time to, power is supplied to the battery monitoring device 15. The potentials of the conductive wires 25 and the bias wires 33 of the battery monitoring device 15 are undefined. After a sufficient power voltage is supplied to the battery monitoring device 15, at the time t1, the battery device 13 is connected with the battery monitoring device 15 (hot-swap). The conductive wires 25 of the battery monitoring device 15 receive power from the respective corresponding battery cells 14. The battery cells 14 of the battery device 13 supply power to the conductive wires 25 via the cell capacitors Ccell and the cell resistors Rcell.

Referring to FIG. 12, in the battery monitoring device 15, from the conductive wire 25 on the high potential side to the conductive wire 25 to the low potential side, the potentials of the conductive wires 25 are substantially at equal intervals.

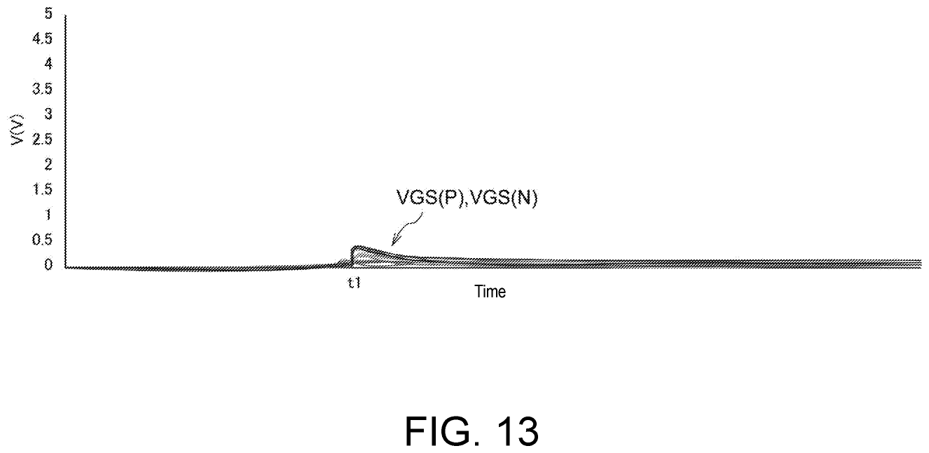

FIG. 13 is a diagram illustrating the gate-source voltages (VGS) of the p-type and n-type transistors of the cell balance switches in the battery system shown in FIG. 11.

At the time t1, in accordance with the hot-swap, the gate-source voltages (VGS) of the p-type transistor and the n-type transistor of the cell balance switch 27 change slightly temporarily. This is because that the potential change is reduced through the capacity coupling between the sources(S) and the gates (G) of the transistors in the cell balance switch 27. The voltage change of the p-type transistor and the voltage change of the n-type transistor are small to an extent of being equal to each other.

According to the embodiment, the cell balance switch circuit, the battery monitoring device, and the battery system capable of alleviating the inequality of the potential difference of each stage of the cell balance switch that may occur at the time when the stack of the cell balance switches 27 in the cell balance switch circuit 17 and the stack of the battery cells 14 in the cell string 18 are connected can be provided. In addition, according to the embodiment, the possibility of applying a voltage that violates breakdown voltage can be reduced, regardless of the connection order of the stack of the cell balance switches 27 and the stack of the battery cells.

The embodiment has various aspects as follows.

A cell balance switch circuit according to a first aspect of the embodiment includes: (n+1) electrodes, configured to be each connected with a common node of adjacent two cells among n cells connected in series, a cell string including the n cells; (n+1) conductive wires, respectively connected with the electrodes; and n cell balance switches, configured to be connected between adjacent two conductive wires among the conductive wires. Each of the cell balance switches includes: a first transistor, connected between adjacent conductive wires of the conductive wires; a bias wire, connected with a gate of the first transistor; and a suppression circuit configured to be connected between the bias wire and the conductive wire. The suppression circuit includes a switch configured to temporarily connect the bias wire and the conductive wire in response to a voltage change of the conductive wire.

In a cell balance switch circuit according to a second aspect following the first aspect of the embodiment, the suppression circuit can include a second transistor having a source and a drain respectively connected with the conductive wire and the bias wire associated with the suppression circuit.

In a cell balance switch circuit according to a third aspect following the second aspect of the embodiment, the suppression circuit can further include a delay circuit connected between the conductive wire associated with the suppression circuit and a gate of the second transistor.

In a cell balance switch circuit according to a fourth aspect following the second or third aspect of the embodiment, the suppression circuit can further include: a resistor, connected between a gate of the second transistor and the conductive wire; and a capacitor, connected between the gate and the drain of the second transistor.

In a cell balance switch circuit according to a fifth aspect following the second, third, or fourth aspect of the embodiment, the cell balance switch can further include a diode connected in a reverse direction between the bias wire and the conductive wire.

In a cell balance switch circuit according to a sixth aspect following the second, third, or fourth aspect of the embodiment, a conductivity type of the second transistor can be the same as a conductivity type of the first transistor of the cell balance switch.

In a cell balance switch circuit according to a seventh aspect following any one of the first to sixth aspects of the embodiment, at least some of the first transistors of the cell balance switches can have a p-channel type.

In a cell balance switch circuit according to an eighth aspect following any one of the first to seventh aspects of the embodiment, at least some of the first transistors of the cell balance switches can have an n-channel type.

A battery monitoring device according to a ninth aspect of the embodiment includes: the cell balance switch circuit according to any one of the first to eighth aspects; a cell selecting switch circuit, including a cell selecting switch connected with each of the cell balance switches; and a cell voltage measuring circuit, connected with a first line and a second line. The first line is connected with odd-numbered electrodes among the electrodes via the cell balance switch circuit and the cell selecting switch circuit, and the second line is connected with even-numbered electrodes among the electrodes via the cell balance switch circuit and the cell selecting switch circuit.

In a battery monitoring device according to a tenth aspect following the ninth aspect of the embodiment, the battery monitoring device can further include a bias wire control circuit, connected with the bias wires. The cell balance switch can further include a resistor connected between the bias wire and the conductive wire. The bias wire control circuit can generate a current flowing to the resistor to turn on the first transistor.

A battery system according to an eleventh aspect of the embodiment includes: the battery monitoring device according to the ninth or tenth aspect; and a cell string, including n cells connected in series.

The disclosure is not limited to the embodiments described above, and can be implemented with various modifications without departing from the spirit of the disclosure. All of these are included in the technical idea of the disclosure.

What is claimed is:

1. A cell balance switch circuit, comprising:
(n+1) electrodes, configured to be each connected with a common node of adjacent two battery cells among n battery cells connected in series, a cell string comprising the n battery cells;
(n+1) conductive wires, respectively connected with the electrodes; and
n cell balance switches, configured to be connected between adjacent two conductive wires among the conductive wires, wherein:
each of the cell balance switches comprises: a first transistor, connected between adjacent conductive wires of the conductive wires; a bias wire, connected with a gate of the first transistor; and a suppression circuit configured to be connected between the bias wire and the conductive wire, and
the suppression circuit comprises a switch configured to temporarily connect the bias wire and the conductive wire in response to a voltage change of the conductive wire.

2. The cell balance switch circuit as claimed in claim 1, wherein the suppression circuit comprises a second transistor having a source and a drain respectively connected with the conductive wire and the bias wire associated with the suppression circuit.

3. The cell balance switch circuit as claimed in claim 2, wherein the suppression circuit further comprises a delay circuit connected between the conductive wire associated with the suppression circuit and a gate of the second transistor.

4. The cell balance switch circuit as claimed in claim 2, wherein the suppression circuit further comprises: a resistor, connected between a gate of the second transistor and the conductive wire;
and a capacitor, connected between the gate and the drain of the second transistor.

5. The cell balance switch circuit as claimed in claim 2, wherein the cell balance switch further comprises a diode connected in a reverse direction between the bias wire and the conductive wire.

6. The cell balance switch circuit as claimed in claim 2, wherein a conductivity type of the second transistor is same as a conductivity type of the first transistor of the cell balance switch.

7. The cell balance switch circuit as claimed in claim 1, wherein at least some of the first transistors of the cell balance switches have a p-channel type.

8. The cell balance switch circuit as claimed in claim 1, wherein at least some of the first transistors of the cell balance switches have an n-channel type.

9. A battery monitoring device, comprising:
the cell balance switch circuit as claimed in claim 1;
a cell selecting switch circuit, comprising cell selecting switches respectively connected with the cell balance switches; and
a cell voltage measuring circuit, connected with a first line and a second line, wherein the first line is connected with odd-numbered electrodes among the electrodes via the cell balance switch circuit and the cell selecting switch circuit, and the second line is connected with even-numbered electrodes among the electrodes via the cell balance switch circuit and the cell selecting switch circuit.

10. The battery monitoring device as claimed in claim 9, further comprising a bias wire control circuit, connected with the bias wires,
wherein the cell balance switch further comprises a resistor connected between the bias wire and the conductive wire, and
the bias wire control circuit generates a current flowing to the resistor to turn on the first transistor.

11. A battery system, comprising:
a battery monitoring device as claimed in claim 9,
a cell string, comprising n battery cells connected in series.
